(19) United States
(12) Patent Application Publication
(10) Pub. No.: US 2026/0070470 A1
(43) Pub. Date: Mar. 12, 2026

(54) Method and Device for Smart Power Control of Fuel Cell Vehicles Using Forward Driving Information: Fuel Cell Power Generation Control Plan

(71) Applicants: Hyundai Motor Company, Seoul (KR); Kia Corporation, Seoul (KR)

(72) Inventors: Sang Pil Jang, Hwaseong-si (KR); Ha Won Sung, Hwaseong-si (KR)

(21) Appl. No.: 19/039,185

(22) Filed: Jan. 28, 2025

(30) Foreign Application Priority Data
Sep. 12, 2024 (KR) 10-2024-0124690

(51) Int. Cl. B60L 58/30; B60L 50/75; H01M 8/04537; H01M 8/04858; H01M 10/44; H01M 16/00; H02J 7/14

(52) U.S. Cl. CPC B60L 58/30; B60L 50/75; H01M 8/04626; H01M 8/04925; H01M 10/44; H01M 16/006; H01M 2220/20; H01M 2250/20; H01M 2250/402; H02J 7/14

(57) ABSTRACT

A method for controlling fuel cell power generation may comprise: obtaining at least one or more of a vehicle speed limit of a forward driving road, whether there is a gradient and gradient data as forward driving information; calculating a total amount value of expected battery output energy based on the obtained forward driving information; and determining a fuel cell power generation output value in a current driving segment in order to charge or discharge a battery based on the total amount value of the expected battery output energy.

### CROSS REFERENCE TO RELATED APPLICATION

The present application claims priority to a Korean provisional application No. 10-2024-0124690, filed on Sep. 12, 2024, the entire contents of which are incorporated herein for all purposes by this reference.

### TECHNICAL FIELD

The present disclosure relates to a method and device for controlling fuel cell power generation by using forward driving information of a fuel cell vehicle, and more particularly, to a fuel cell power generation control method and device for predictive control of a battery state of charge (SOC) by considering a vehicle speed limit of a forward driving road, whether the forward driving road has a gradient, and/or gradient data, which are obtained from a peripheral device of a vehicle.

### BACKGROUND

Generally, a moving object (e.g., a vehicle herein, which may refer to a manned vehicle, unmanned vehicle, mobile robot, etc.) is controlled depending on a current state of the moving object and a current driver's will. In a conventional fuel cell power generation control method for a fuel cell electric vehicle (FCEV), an FC power map according to an SOC of a high-voltage battery may be determined by calculating a vehicle output power demand based on a driver's acceleration pedal engagement amount and a service output power of vehicle accessories.

Specifically, a conventional FCEV controls fuel cell power generation by calculating a vehicle output power demand based on a driver's acceleration pedal engagement amount and a service output power of vehicle accessories and thus by determining an FC power map according to an SOC of a high-voltage battery. In this case, even if an upcoming segment of a road to be driven on is a long uphill segment or a long downhill segment, since power is generated merely based on the FC power map corresponding to a current driving segment, there may be a problem in that a battery SOC necessary for the future driving segment is not sufficiently secured.

For example, in the case of a FC vehicle (e.g., a large FC truck, a large FC bus), high speed uphill driving requires a high output power because the vehicle has a heavy weight, but an output power from two fuel cells applied to the current vehicle may not be sufficient, which may make it necessary to keep using a battery output power. This may cause a battery SOC value to be excessively discharged. This may result in no/low battery SOC value, leading to a problem of low speed driving because of the lack of supply output power.

If a FC vehicle maintains regenerative braking to keep a constant speed while driving on a long downhill, there may be a problem in that a battery SOC value is excessively charged and regenerative braking may no longer be performed after the battery SOC value is fully charged, such that the vehicle speed may be maintained by using a mechanical retarder or a wheel brake.

That is, an existing FC vehicle has a problem that a battery SOC value is not sufficiently secured to be charged and discharged for future driving because FC power generation depends on an FC power map that is determined based on a vehicle output power demand and a battery SOC value, without consideration of whether a future forward driving segment is an uphill segment or a downhill segment.

### SUMMARY

The following summary presents a simplified summary of certain features. The summary is not an extensive overview and is not intended to identify key or critical elements.

Systems, apparatuses, and methods are described for smart power control of fuel cell vehicles using forward driving information. A method for controlling fuel cell power generation may comprise: determining, for a vehicle driving on a current driving segment of a road, upcoming driving segment information comprising, for an upcoming driving segment of the road: a vehicle speed limit of the upcoming driving segment of the road, and at least one of whether there is a gradient to the upcoming driving segment of the road, or gradient data of the upcoming driving segment of the road; determining, based on the upcoming driving segment information, a total amount of expected battery output energy expected to be output by a battery of the vehicle while driving on the upcoming driving segment; and while the vehicle is driving on the current driving segment, charging or discharging the battery based on a fuel cell power generation output value associated with the upcoming driving segment and on the total amount of the expected battery output energy.

A device, of a vehicle, for controlling fuel cell power generation for the vehicle by controlling a battery output, may comprise: a peripheral device configured to determine upcoming driving segment information comprising: a vehicle speed limit of an upcoming driving segment of a road on which the vehicle is driving, and at least one of whether there is a gradient of the upcoming driving segment or gradient data of the upcoming driving segment; a processor; and a memory configured to store at least one instruction. The at least one instruction, when executed by the processor, configures the device to: determine, based on the upcoming driving segment information, a total amount of expected battery output energy expected to be output by a battery of the vehicle while driving on the upcoming driving segment, and while the vehicle is driving on a current driving segment of the road, charge or discharge the battery based on a fuel cell power generation output value associated with the upcoming driving segment and based on the total amount of the expected battery output energy.

A method performed by a vehicle may comprise: identifying, by the vehicle driving on a first driving segment of a road, an expected vehicle speed of an upcoming driving segment of the road, and gradient information of the upcoming driving segment of the road; determining, based on the expected vehicle speed and the gradient information, a total amount of expected battery output energy expected to be output by a battery of the vehicle while driving on the upcoming driving segment; and controlling the vehicle to, before driving on the upcoming driving segment, charge or discharge the battery based on: expected fuel cell power generation output, of a fuel cell of the vehicle, associated with the upcoming driving segment and the total amount of the expected battery output energy.

These and other features and advantages are described in greater detail below.

### BRIEF DESCRIPTION OF THE DRAWINGS

FIG. 1 show a block diagram illustrating constituent modules of a moving object equipped with a fuel cell power generation control device according to an example of the present disclosure.

FIG. 2A and FIG. 2B show flowcharts of a method for controlling fuel cell power generation of a moving object according to another example of the present disclosure.

FIG. 3 show a view of predicting a change of a battery SOC value when a forward driving road is a long uphill according to an example of the present disclosure.

FIG. 4 show a view of predicting a change of a battery SOC value when a forward driving road is a long downhill according to an example of the present disclosure.

FIG. 5A and FIG. 5B show a predictive control process for a battery SOC prediction value of a passenger hybrid vehicle through a fuel cell control device according to another example of the present disclosure.

FIG. 6 show a block diagram showing a passenger vehicle power map according to an example of the present disclosure.

FIG. 7A and FIG. 7B show a predictive control process for a battery SOC value of a FC vehicle through a fuel cell control device according to another example of the present disclosure.

FIG. 8 show exemplifying a flowchart of an operating mechanism of a fuel cell power generation control device according to another example of the present disclosure.

FIG. 9 show a graph showing an estimation result for a change of a battery SOC value based on a fuel cell control device being on/off according to another example of the present disclosure.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

Electric devices are described related to battery charging and discharging on a moving object, including a drive motor and a starter-generator (HSG) that can charge the battery by converting the braking and inertial energy of the vehicle into electrical energy during regenerative braking or deceleration.

A method for charging or discharging a battery SOC value before an uphill or downhill segment by controlling an FC power generation amount in a current driving segment is described herein to address various problems discussed herein, for example. Such a method may calculate a battery SOC value necessary for a future driving segment by using information on a forward driving road, where the information may be obtained from a peripheral device of a vehicle comprising the battery.

, a method can be suggested that minimize driving issues through smart power control by limiting the target battery's SOC change or adjusting the battery charging/discharging rate based on the reliability of the driving route. The reliability of the driving route refers to the confidence in the slope information of the current driving path received by the smart power control logic. Even if the driving route changes, if the slope information is similar, for example, if the route changes from uphill to uphill, the reliability can be considered high. On the other hand, if the slope information changes significantly, such as from uphill to downhill, there could be a possibility that the route change causes a reversal of the slope, in which case the reliability is judged to be low.

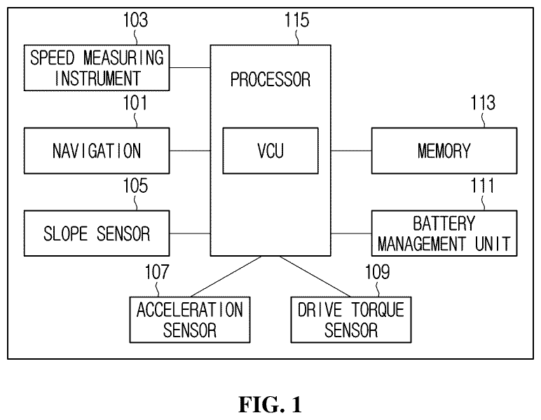

Hereinafter, referring to FIG. 1, a fuel cell power generation control device of a vehicle will be described according to an example of the present disclosure.

FIG. is a block diagram illustrating constituent modules of a vehicle equipped with a fuel cell power generation control device according to an example of the present disclosure.

A fuel cell power generation control device may be mounted in a hydrogen electric vehicle such as a large hydrogen electric truck. A smart power control device may perform power control of a vehicle by considering road gradient information of a point a predetermined distance or more ahead of the vehicle.

The fuel cell power generation control device may include a peripheral device (e.g., a peripheral computing device), which may include, a navigation unit 101, a speed measuring instrument 103 (e.g., speedometer), a slope sensor 105, an acceleration sensor 107, a drive torque sensor 109, a battery management unit 111, and/or a memory 113. The peripheral device may be a device for obtaining forward driving information of the vehicle and may further include various devices other than the constituent elements illustrated in FIG. 1. The peripheral device may be and/or comprise, for example, a connected car Navigation Cockpit (ccNc), which may be configured to perform a function of obtaining the forward driving information. Accordingly, the forward driving information according to the present disclosure may be obtained from the ccNc. The navigation unit 101 may send out and/or receive road information and/or repeated driving route information. Road information may include a vehicle speed limit of a forward driving road on which a vehicle is driving. Repeated driving route information may be a route registered by a user (e.g., searched for, saved, requested by the user) and/or an automatically registered route automatically registered (e.g., saved/recognized) based on the vehicle driving said route repeatedly (e.g., a predetermined number of times). The navigation unit may comprise, for example, a global positioning system (GPS) device and/or component, or another computing device loaded with and/or able to receive/determine road and/or route/positioning information.

The speed measuring instrument 103 may measure/sense a driving speed of the vehicle. The acceleration sensor 107 may measure an acceleration of the vehicle, which may be in a different direction from the driving direction (e.g., if the vehicle is slowing and/or turning). In addition, a weight of the vehicle may be determined/calculated based on information from the acceleration sensor 107 and the drive torque sensor 109. the weight of the vehicle may also, or alternatively, be determined based on information about the vehicle (e.g., stored in the memory), and/or other information about current cargo and/or passengers of the vehicle, but determining the weight of the vehicle based on acceleration and drive torque may be more instantaneously accurate.

The battery management unit 111 may be configured to enhance energy efficiency by managing a state of charge (SOC) of a vehicle battery (e.g., optimally managing the SOC of the vehicle's battery). Such a battery management unit may be implemented as a battery management system (BMS). The battery management unit may monitor the voltage, current and/or temperature of a vehicle battery (e.g., in real time or near real time) by using one or more sensors configured to detect/measure/report those values of the battery. The battery management unit may prevent overcharge and/or overdischarge of a vehicle battery based on the monitoring. In addition, the battery management unit may calculate a SOC of a vehicle battery (battery SOC) by current and/or voltage measured by sensors. A vehicle battery may supply power to an electrical device mounted in the vehicle, such as an electronic control unit (ECU) and/or a drive motor.

The memory 113 may store instructions (e.g., of an application and/or program) and/or various types of data for controlling the vehicle. At a request of a processor (e.g., the processor 115/VCU in FIG. 1), load the application or read and record data. The memory may include a non-volatile memory and a volatile memory.

The processor 115 may perform overall control of the vehicle. The processor 115 may have at least one processing module. Each control-related function of the vehicle, and/or as discussed herein, may be implemented in a single processing module, or be implemented in a corresponding processing module among a plurality of modules. In relation to the present disclosure, the processor 115 may control the vehicle to control fuel cell power generation by executing the instructions (e.g., an application) and/or accessing data stored in the memory.

Specifically, the processor 115 may obtain/determine forward driving information during driving of the vehicle. the forward driving information may comprise at least one of a vehicle speed limit on a forward driving road on which the vehicle is driving, whether the forward driving road has a gradient currently and/or in an upcoming segment, and gradient data of the upcoming segment. The processor 115 may determine/calculate a total amount of expected battery output energy based on the obtained forward driving information. The processor 115 may cause charging or discharging of the batter based on a determined fuel cell power generation output value in a current driving segment and based on the total amount of expected battery output energy.

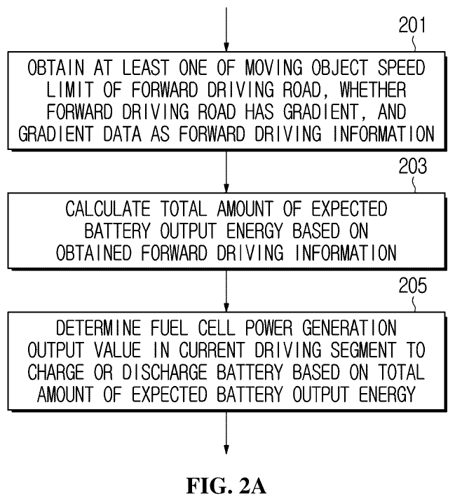

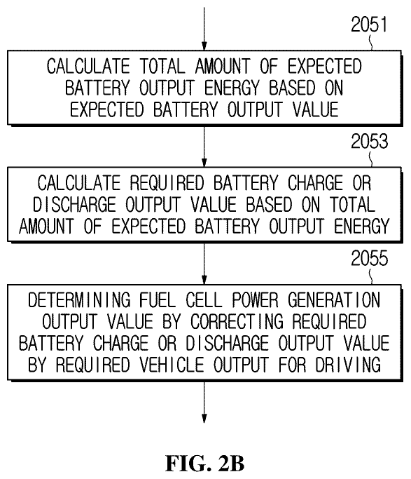

The fuel cell power generation control device of the vehicle according to the present disclosure may be a device configured to implement processing of fuel cell power generation control through a processor 115 by including at least the speed measuring instrument 103, the navigation 101, the slope sensor 105, the acceleration sensor 107, the drive torque 109, the memory 113, and/or the battery management unit 111. The processing may be implemented by at least a portion of the processor 115 such as at least one processing module (e.g., processor, and the memory may function as a VCU. The above-described processing of the processor will be described in detail through FIG. 2A and FIG. 2B.

FIG. 2A and FIG. 2B are flowcharts of a method for controlling fuel cell power generation of a vehicle according to another example of the present disclosure.

Referring to FIG. 2A, a method for controlling fuel cell power generation of a vehicle according to the present disclosure may include obtaining at least one of a vehicle speed limit of a forward driving road, whether the forward driving road has a gradient, and gradient data as forward driving information (201), determining/calculating a total amount of expected battery output energy based on the obtained data (203), and determining a fuel cell power generation output value in a current driving segment to charge or discharge a battery based on the total amount of the expected battery output energy (205).

The obtaining of at least one of the vehicle speed limit of the forward driving road, whether the forward driving road has a gradient, and the gradient data as the forward driving information (S201) may be performed by peripheral device(s) of the vehicle (e.g., as in FIG. 1).

For example, a navigation unit (e.g., navigation unit 101) may provide information on a vehicle speed limit of a forward driving road (e.g., of a current segment of a road on which the vehicle is traveling and/or an upcoming segment of the road on which the vehicle is traveling). A speed measuring instrument (e.g., speed measuring instrument 103) may provide a driving speed of the vehicle. A gradient sensor (e.g., slope sensor 105) may provide information on whether the forward driving road has a gradient and/or gradient data about an angle of the gradient/road and the like. An acceleration sensor (e.g., acceleration sensor 107) and/or a drive torque sensor (e.g., 109) may provide information to calculate a weight of the vehicle.

The determining and/or calculating of the total amount of the expected battery output energy based on the obtained forward driving information (S203) may be performed via an operation of multiplying an expected battery charge and/or discharge output value (hereinafter, expected battery charge/discharge output value) by an expected future driving time. The expected future driving time may be a value obtained by dividing a forward distance (e.g., of an upcoming driving segment and/or an upcoming driving segment with a gradient) by a vehicle speed and/or obtained vehicle speed limit. A required battery output value may be determined by dividing the total amount of the expected battery output energy by an expected driving time of a current segment.

As for the expected battery output value, If a forward driving road of a vehicle detected by a slope sensor is uphill (e.g., an ascending road segment, e.g., an ascending road over at least a threshold distance), an expected battery charge output value may be an expected battery discharge output value. The expected battery discharge output value may be obtained by subtracting an expected fuel cell power generation output value from an expected gradient driving output value (e.g., when a vehicle is being driven over the ascending road segment).

If a forward driving road of the vehicle detected by the slope sensor is downhill (e.g., a descending road segment, e.g., a descending road over at least a threshold distance), the expected battery output value may be an expected battery charge output value. Herein, the expected battery charge output value may be an expected gradient driving output value during regenerative braking (e.g., over the descending road segment).

The determining of the fuel cell power generation output value in the current driving segment to charge or discharge the battery based on the total amount of the expected battery output energy (S205) may be performed as shown in FIG. 2B.

Referring to FIG. 2B, S205 may include determining/calculating the total amount of the expected battery output energy based on the expected battery output value (2051), calculating a required battery charge or discharge output value based on the total amount of the expected battery output energy (2053), and determining a fuel cell power generation output value by correcting the required battery charge or discharge output value by a required vehicle output for driving (2055).

According to FIG. 2B, the total amount of the expected battery output energy may be determined/calculated based on the expected battery output value (2051). The total amount of the expected battery output energy may be determined by multiplying an expected battery charge/discharge output value and an expected future driving time.

The expected battery output value may be obtained by a VCU through a vehicle dynamics equation, and the vehicle dynamics equation may be Equation 1 below, for example.

$$\begin{matrix}{F}_{t r action} = ( {F}_{d r a g} + {F}_{roll} + {F}_{grade} ) \\ = 0.5 ⋆ p ⋆ {C}_{d} ⋆ A ⋆ {V}^{2} + mg ⋆ ( {C}_{r} cos θ + sin θ )\end{matrix} \qquad [ Equation 1 ]$$

Here, F_{traction} is a traction force, F_{drag} is air drag, Fᵣₒₗₗ is rolling resistance, and F_{grade} is gradability. m is a vehicle weight. g is the acceleration of gravity. ρ is air density, Cd is an air resistance coefficient, A is a front area, and Cr is a rolling resistance coefficient.

The calculating of the required battery charge or discharge output value based on the total amount of the expected battery output energy (2053) may be performed by dividing an expected battery charge/discharge energy value by an expected future time of a vehicle (e.g., a time at/until which the vehicle will complete a current road segment and begin driving on an ascending/descending upcoming driving segment). Herein, the expected future driving time of the vehicle may be a value obtained by dividing a current segment distance by a vehicle speed.

The determining of the fuel cell power generation output value by correcting the required battery charge or discharge output value by the required vehicle output for driving (2055) may be performed by adding a required vehicle output value to the required battery charge/discharge output value of the current segment that is obtained at step 2053. Herein, the required vehicle output value may be a value that is determined/calculated based on a driver's acceleration pedal engagement amount (e.g., detected via a sensor associated with the acceleration pedal) and/or a service output power of vehicle accessories of the fuel cell vehicle (e.g., that may be currently under mass production or otherwise).

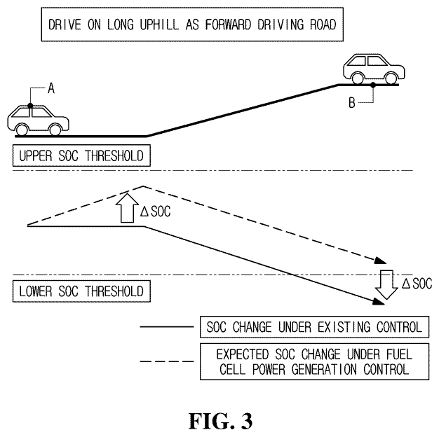

FIG. 3 is a view of predicting a change of a battery SOC value if a forward driving road is a long uphill according to another example of the present disclosure.

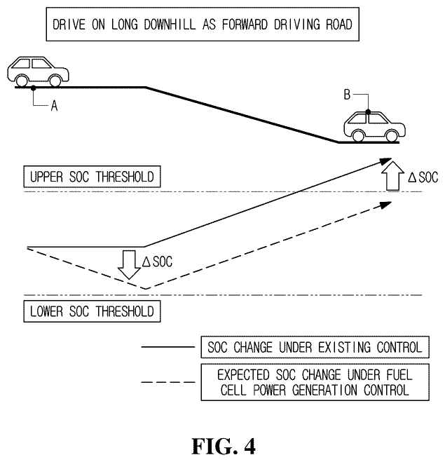

FIG. 4 is a view of predicting a change of a battery SOC value if a forward driving road is a long downhill according to another example of the present disclosure.

Referring to FIG. 3 and FIG. 4, a processor of a fuel cell power generation control device may obtain forward information via a peripheral device of a vehicle, determine/calculate a battery SOC necessary for a future driving segment, control an FC power generation amount in a current driving segment, and charge or discharge a battery SOC in advance of the future driving segment.

Referring to the upper diagram of FIG. 3, if the vehicle moves from a point A to a point B, the forward driving road is uphill. In the lower diagram of FIG. 3, a change of a battery SOC value in the existing control of FC vehicles is expressed by the solid line-in the existing control, uphill driving is performed by power generation of an FC through an FC power map not of a forward driving road (e.g., future road segment) but of a current driving segment. In the existing case, a battery SOC capacity to be discharged by the uphill driving is not secured ahead of time, and the battery SOC value is lowered below a lower SOC threshold. That is, if a forward driving road is uphill in existing FC vehicle battery management, a lower SOC threshold may be violated, but an upper SOC threshold may not be a matter of concern.

In the present disclosure, based on information obtained from a peripheral device of the vehicle, if it is determined that a forward driving road (e.g., upcoming road segment) is uphill (e.g. for at least a threshold distance and/or gradient angle), a battery SOC necessary for uphill road driving may be charged beforehand (e.g., during driving on a current driving segment). A corresponding change of the battery SOC value is expressed in the lower portion of FIG. 3 by the dotted line. In this case, unlike the existing battery management control of FC vehicles based on the existing FC power map, the battery SOC value may be maintained without being lowered below the lower SOC threshold even when driving on the long uphill road.

The FC power map used in the existing vehicles may be a control algorithm of a fuel cell system according to an SOC of a high-voltage battery based on a required vehicle output calculated from a driver's acceleration pedal engagement amount and a service output power of vehicle accessories.

FIG. 4 shows an example of the vehicle moving from the point A to the point B, when the road from point A to point B includes an upcoming segment (e.g., a forward driving road) that is downhill (e.g., for at least a threshold distance and/or gradient angle, or at all). A change of a battery SOC value in the existing control of mass-produced FC vehicles is shown in the bottom portion of FIG. 4 by the solid line. In the existing control, downhill driving is performed by power generation of an FC based on an FC power map of a current driving segment (e.g., not considering a forward driving road, otherwise referred to as an upcoming road segment or driving segment). In the existing case, a battery SOC capacity to be charged by the downhill driving is not secured/achieved, so the battery SOC value is raised beyond an upper SOC threshold. Unlike uphill driving, if the forward driving road (upcoming segment) is a downhill, only the upper threshold may be a matter of concern, while the lower threshold may not be a matter of concern.

In the present disclosure, based on information obtained from a peripheral device of the vehicle, if it is determined that a forward driving road is downhill (e.g., for at least a threshold distance and/or gradient, or at all), a battery SOC necessary for the upcoming downhill road driving may be discharged beforehand (e.g., during driving on a current driving segment). A corresponding change of the battery SOC value is expressed by the dotted line. In this case, unlike the existing FC vehicles based on the existing FC power map, the battery SOC value may be maintained without being raised beyond the upper SOC threshold, even when driving on a long downhill road.

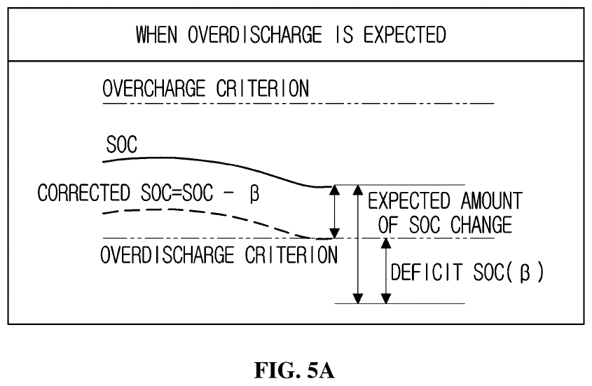

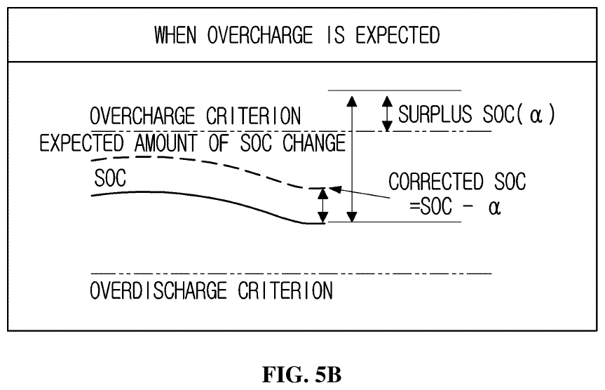

FIG. 5A and FIG. 5B are views showing a predictive control process for a battery SOC of a passenger hybrid vehicle through a fuel cell control device according to another example of the present disclosure.

Referring to FIG. 5A and FIG. 5B, a fuel cell control method according to the present disclosure may change a charge amount or a discharge amount by inputting a corrected SOC value, which is obtained by adding or subtracting a surplus or deficit SOC value to or from an actual SOC value received from a battery management unit, into a passenger vehicle power map, when overcharge or overdischarge is expected based on whether a forward driving road (e.g., upcoming road segment) having a gradient.

FIG. 5A shows a fuel cell power generation control process when a forward driving road is uphill and overdischarge of a battery SOC value is expected based on the detected upcoming uphill segment. A difference of SOC value between a preset reference point and an overdischarge reference point is referred to as a deficit SOC value and may be expressed by B. A corrected battery SOC value may be obtained by subtracting an expected deficit battery SOC value (B) (e.g., an expected deficit below the overdischarge reference point during driving on a future driving road segment) from an actual battery SOC value. The corrected battery SOC value thus obtained may be input into a passenger vehicle power map, and the battery may be further charged by selecting any one battery SOC value.

FIG. 5B shows a fuel cell power generation control process when a forward driving road is downhill and overcharge of a battery SOC value is expected based on the detected upcoming downhill segment. A difference of SOC value between a preset reference point and an overcharge reference point is referred to as a surplus SOC value herein, and is referred to herein as a. A corrected battery SOC value may be obtained by adding a surplus battery SOC value (a) (e.g., beyond the overcharge reference point during driving on a future driving road/upcoming road segment) to an actual battery SOC value. As in FIG. 5A, the corrected battery SOC value thus obtained may be input into a passenger vehicle power map, and the battery may be further discharged by selecting any one battery SOC value.

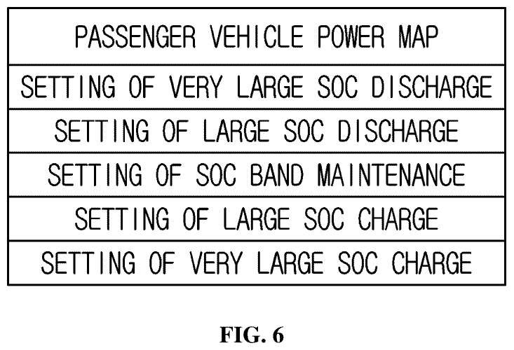

FIG. 6 is a block diagram showing a passenger vehicle power map according to another example of the present disclosure.

Referring to FIG. 6, the passenger vehicle power map may consist of a plurality of grades according to a necessary battery SOC charge or discharge degree, and a battery SOC value may be output by selecting any one value of the plurality of grades. For example, the grades may include: a setting of a very large SOC discharge, a setting of a large SOC discharge, a setting of SOC band maintenance, a setting of a large SOC charge, and a setting of a very large SOC charge. However, this is merely one example, and a passenger vehicle power map, according to the present disclosure, may divided into a plurality of grades that are different from these grades and/or have a different number of grades than 5. For example, the passenger vehicle power map may have equal to or greater than 5 grades (e.g., 10 grades, 12 grades).

A corrected SOC value, which may be input into the passenger vehicle power map, may be determine/calculated based on an actual battery SOC value (e.g., received from a battery management system (BMS) of a battery management unit) and an SOC value to be surplus or deficit. The battery of the BMS may be, for example, a rechargeable battery system like a Lithium-ion battery.

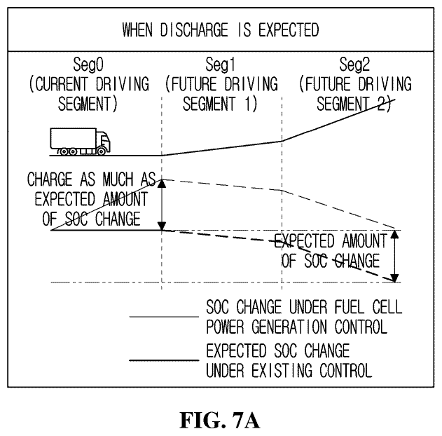

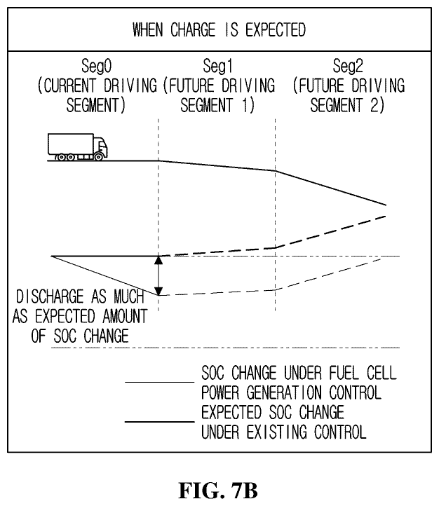

FIG. 7A and FIG. 7B show a predictive control process for a battery SOC value of a FC vehicle through a fuel cell control device according to examples of the present disclosure.

Referring to FIG. 7A and FIG. 7B, an expected amount of battery SOC change may be determined/calculated based on whether a forward driving road (e.g., upcoming road segment) has a gradient. The expected amount may be converted into (e.g., used to determine) a required battery charge/discharge output in a current driving segment, and thus control a fuel cell power generation output. Thus, it is possible to secure an SOC value which is high enough to be used in a forward driving segment (e.g., upcoming road segment).

FIG. 7A shows a fuel cell power generation control process when a forward driving road is uphill and discharge of a battery SOC value is expected. First, in order to obtain a required battery charge output value of a current driving segment, an expected battery charge output value for the uphill segment may be calculated. The expected battery charge output value may be an expected gradient driving output value during regenerative braking. The required battery charge output value of the current segment may be obtained by dividing the expected battery charge output value by an expected driving time of the current segment.

In FIG. 7A, a driving segment is divided into a current driving segment Seg 0 and a forward driving segment (e.g., upcoming road segment), and the forward driving segment is divided again into a first future driving segment Seg 1 and a second future driving segment Seg 2. In the current driving segment Seg 0, an expected amount of battery SOC change in the forward driving segment (Seg 1 and Seg 2) of a vehicle may be calculated/determined, and charge may be performed in advance. In a control method of the related art, an amount of battery SOC change may not be maintained but have a value below a preset reference point, and thus discharge may occur. The first future driving segment Seg 1 may be slightly uphill, on which a battery SOC value is slightly discharged at the preset reference point, and the second future driving segment Seg 2 may be steeply uphill, on which the battery SOC value may be more drastically discharged at the preset reference point than in the first future driving segment Seg 1.

In the case of a fuel cell power control device, since charge may be performed during a current driving segment as much as an amount of battery SOC change, even driving on a long uphill may not cause discharge, and a battery SOC value may not be lowered below a preset reference value. The first future driving segment Seg 1 is a long slight uphill on which, as compared with the second future driving segment Seg 2, both the existing control and the fuel cell power generation control may have a slight amount of battery SOC value change. On the other hand, the second future driving segment Seg 2 is a steep uphill, on which an amount of battery SOC change may also be relatively drastic.

FIG. 7B shows a fuel cell power generation control process when a forward driving road is downhill and charge of a battery SOC value is expected. First, in order to obtain a required battery charge output value of a current driving segment, an expected battery discharge output value for a long downhill may be calculated. The expected battery discharge output value may be calculated by subtracting an expected fuel cell power generation value from an expected gradient driving output value when a vehicle is being driven. The required battery charge output value of the current segment may be obtained by dividing the expected battery discharge output value by an expected driving time of the current segment.

For example, in FIG. 7B, a driving segment is divided into a current driving segment Seg 0 and a forward driving segment, and the forward driving segment is divided again into a first future driving segment Seg 1 and a second future driving segment Seg 2. In the current driving segment Seg 0, an expected amount of battery SOC change in the forward driving segment may be calculated/determined, and discharge may be performed in advance. In existing battery maintenance, an amount of battery SOC change may not be maintained but have a value exceeding a preset reference point, and thus overcharge may occur. The first future driving segment Seg 1 is a slight downhill, on which a battery SOC value may be slightly charged at the preset reference point, and the second future driving segment Seg 2 is a steep downhill, on which the battery SOC value may be more drastically charged at the preset reference point than in the second future driving segment Seg 2.

In the case of a fuel cell power control device herein, since discharge may be performed in a current driving segment as much as an amount of battery SOC change, even driving on a long and/or steep downhill may not cause overcharge, and a battery SOC value may not be raised beyond a preset reference value. The first future driving segment Seg 1 is, in the illustrative example, a long slight downhill on which, as compared with the second future driving segment Seg 2, both the existing control and the fuel cell power generation control may have a slight amount of battery SOC value change. On the other hand, the second future driving segment Seg 2 is a steep uphill, on which an amount of battery SOC change may be relatively drastic.

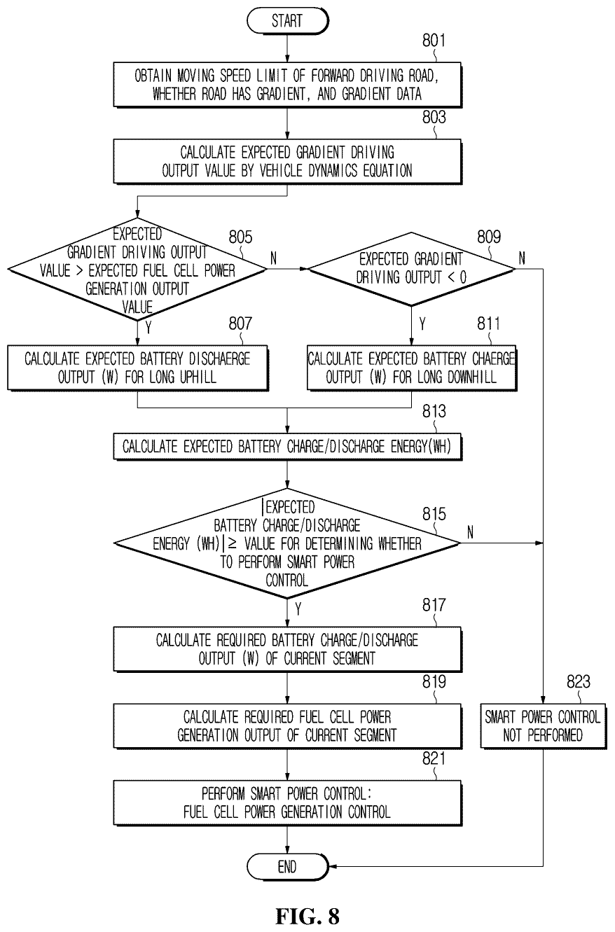

FIG. 8 shows a flowchart of an operating mechanism of a fuel cell power generation control device according to another example of the present disclosure. For convenience, FIG. 8 is described by way of an example in which the steps are performed by a processor circuit. One, some, or all steps of the example method of FIG. 8, or portions thereof, may be performed by one or more other circuits. One or some, steps of the example method of FIG. 8 may be omitted, performed in other orders, and/or otherwise modified, and/or one or more additional steps may be added.

A process of operating a fuel cell power generation control device may be described with reference to FIG. 8 as follows. Information on a speed limit of a future forward driving segment, whether the segment has a gradient, gradient data and a distance may be input from a peripheral device of a vehicle may be determined (801). Also, or alternatively, a vehicle weight may be determined (e.g., for input and/or based on a vehicle acceleration sensor and/or a drive torque).

Based on the vehicle dynamics equation shown in Equation 1, for example, an expected gradient driving output value of the future driving segment may be determined/calculated (803). Herein, the expected gradient driving output value may be an expected required battery output value.

The expected gradient driving output value and an expected fuel cell power generation output value may be compared (805). If the expected gradient driving output value is larger (805-Y), it may be determined that the forward driving segment (e.g., upcoming road segment) is uphill, and an expected battery discharge output value may be determined/calculated (807). Herein, the expected battery discharge output value may be determined/calculated by multiplying a battery efficiency and a value obtained by subtracting the expected fuel cell power generation output value from the expected gradient driving output value.

If the expected gradient driving output value is smaller than or equal to the expected fuel cell power generation output value (805—N), it may be determined whether the expected gradient driving output value is a negative number (809). If the value is a negative number (809—Y), it may be determined that the forward driving segment is downhill, and an expected battery charge output value may be calculated (811). Herein, the expected battery charge output value may be a value obtained by dividing the expected gradient driving output value by a battery efficiency. If the expected gradient driving output value is smaller than or equal to the expected fuel cell power generation output value, but the expected gradient driving output is not negative (809—N), the smart power control process for fuel cell power generation control disclosed herein may be terminated (823).

Based on the expected battery charge/discharge output value (e.g., in 807 or 811), an expected battery charge/discharge energy value may be calculated/determined (813). The expected battery charge/discharge energy value may be obtained (e.g., calculated/determined) by multiplying the expected battery charge/discharge output value and an expected future driving time. It may be determined whether the expected battery charge/discharge energy value calculated is larger than a preset value for determining whether to perform fuel cell power generation control (815). If the expected battery charge/discharge energy value is larger or equal (815—Y), a required battery charge/discharge output value of a current segment may be calculated/determined (817). The required battery charge/discharge output value of the current segment may be a value obtained by dividing the expected battery charge/discharge energy value by an expected driving time of the current segment. If the expected battery charge/discharge energy value is smaller than the preset value for determining whether to perform fuel cell power generation control (815—N), smart power control for fuel cell power generation control may not be performed, and the operating mechanism may be terminated (823).

Based on the required battery charge/discharge output value of the current segment (e.g., obtained at 817), a required fuel cell power generation output value of the current segment may be determined/calculated (819). The required fuel cell power generation output value of the current segment may be a value obtained by adding a required vehicle output value to the required battery charge/discharge output value of the current segment.

By controlling a fuel cell through the fuel cell power generation output value, fuel cell power generation control may be performed to secure a required battery SOC value for a future forward segment in advance. The operating mechanism for the fuel cell power generation control may be terminated. In principle, the fuel cell power generation control device may be constantly/continuously/repeatedly operated while the vehicle is running, but the present disclosure is not necessarily limited thereto (e.g., it may be enabled/disabled based on user input and/or settings such as default and/or subscriber settings).

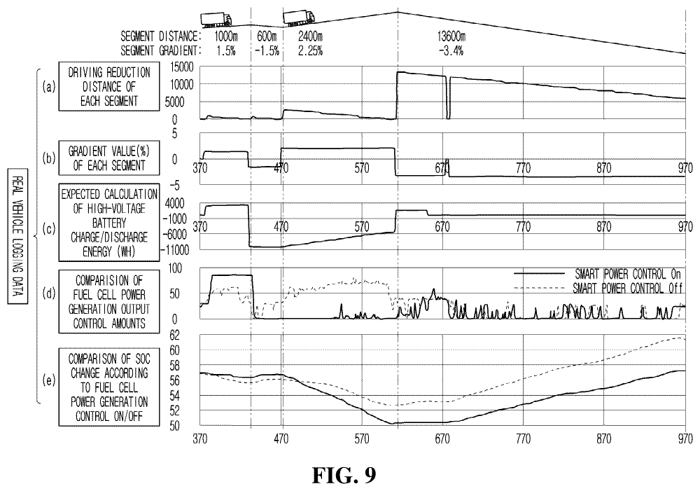

FIG. 9 is a graph showing an estimation result for a change of a battery SOC value based on a fuel cell power generation control device being on/off according to another example of the present disclosure. Referring to FIG. 9, according to whether a vehicle according to the present disclosure controls fuel cell power generation, estimation results for battery SOC values during actual driving are compared and described.

In FIG. 9, (a) is a graph representing a driving reduction of each driving segment of a vehicle, (b) is a graph expressing a gradient of each driving segment by percentage (%), and (c) is a graph expressing an expected value of high-voltage battery charge/discharge energy calculation according to a gradient of each driving segment. In addition, (d) is a graph expressing a fuel cell power generation control amount calculated based on the graph (c) according to the on/off of fuel cell power generation control, and (e) is a graph for comparing changes of battery SOC values according to the on/off of a fuel cell power generation control device based on the above values.

For example, as for forward driving information received from a peripheral device of a vehicle, a segment distance is 2,400 m and a gradient value is 2.2%, and when a long uphill is expected, an expected gradient driving output value is calculated first. Based on the expected gradient driving output value, an expected required high-voltage battery charge energy value may be calculated. Specifically, in this case, the expected required high-voltage battery charge energy value may be 4,000 Wh.

Based on the expected required high-voltage battery charge energy value, if the fuel cell power control device is on, a fuel cell power generation output control value may be increased as compared to when the fuel cell power control device is off. Thus, a battery SOC charge value of the vehicle may be increased when the fuel cell power control device is on.

On the other hand, as for the forward driving information received from the peripheral device of the vehicle, a segment distance is 13600 m and a gradient value is-3.4%, and when a long downhill is expected, an expected gradient driving output value is calculated like in the case of a long uphill. Based on the expected gradient driving output value, an expected required high-voltage battery discharge energy value may be calculated. Specifically, in this case, the expected required high-voltage battery discharge energy value may be −6,000 Wh.

Based on the expected required high-voltage battery discharge energy value, if the fuel cell power control device is on, a fuel cell power generation output control value may be decreased as compared to when the fuel cell power control device is off. Thus, a battery SOC reduction value of the vehicle may be increased when the fuel cell power control device is on.

The present disclosure allows for, based on information on a forward driving road obtained, if the forward driving road includes an uphill segment (e.g., a long uphill segment greater than a threshold length), a battery SOC value may be charged in advance, and a vehicle speed may be maintained during long uphill driving so that the driving performance of the vehicle may be improved. Also, or alternatively, if the forward driving road includes a downhill segment (e.g., a long downhill segment greater than a threshold length), the battery SOC value may be discharged in advanced, and thus performance may be improved during long downhill driving, and it may be expected that the maintenance cost is reduced because the amount of brake pad wear is reduced.

The present disclosure is technically directed to providing a method and device for controlling fuel cell power generation of a vehicle by efficiently controlling a battery SOC value based on information on a forward driving road obtained from a peripheral device of the vehicle.

The technical problems solved by the present disclosure are not limited to the above technical problems, and other technical problems which are not described herein will be clearly understood by a person having ordinary skill in the technical field, to which the present disclosure belongs, from the following description.

According to the present disclosure, a method is provided for controlling fuel cell power generation. The method may comprising: obtaining at least one or more of a vehicle speed limit of a forward driving road, whether there is a gradient and gradient data as forward driving information; calculating a total amount value of expected battery output energy based on the obtained forward driving information; and determining a fuel cell power generation output value in a current driving segment in order to charge or discharge a battery based on the total amount value of the expected battery output energy.

According to an example of the method of the present disclosure, the method of claim 1, wherein the total amount value of the expected battery output energy is determined by multiplying an expected battery discharge output value and an expected future driving time, and
wherein a required battery output value is determined by dividing the total amount value of the expected battery output energy by an expected driving time of the current segment.

According to an example of the method of the present disclosure, the method of claim 2, wherein based on the forward driving road being a long uphill, the expected battery output value is an expected battery discharge output value, and wherein the expected battery discharge output value is calculated by subtracting an expected fuel cell power generation value from an expected gradient driving output value.

According to an example of the method of the present disclosure, the method of claim 2, wherein based on the forward driving road being a long downhill, the expected battery output value is an expected battery charge output value, and wherein, the expected battery charge output value is an expected gradient driving output value during regenerative braking.

According to an example of the method of the present disclosure, the method of claim 2, wherein the total amount value of the expected battery output energy is determined by multiplying the expected battery charge or discharge output value and the expected future driving time.

According to an example of the method of the present disclosure, the method of claim 2, wherein further comprising determining a fuel cell power generation output value by correcting the required battery charge or discharge output value by a required vehicle output value for driving, and wherein the fuel cell power generation output value is determined by adding the required vehicle output value to the required battery charge or discharge output value.

According to an example of the method of the present disclosure, the method of claim 1 to claim 6, wherein the vehicle is a fuel cell vehicle.

According to an example of the method of the present disclosure, the method of claim 2, wherein based on the vehicle being a passenger hybrid vehicle, the required battery output value is converted into a battery charge or discharge output value by selecting one grade among a plurality of passenger vehicle power map grades.

According to an example of the method of the present disclosure, the method of claim 2, wherein the expected battery charge or discharge output value is compared with an expected fuel cell power generation output value and wherein based on the expected battery charge or discharge output value being smaller than the expected gradient driving output value, smart power control for fuel cell power generation control is terminated.

According to an example of the method of the present disclosure, the method of claim 1, wherein whether or not to control fuel cell power generation is determined by comparing the total amount value of the expected battery output energy and a preset reference value.

According to another example of the present disclosure, a device is provided controlling a battery output value through forward driving information. The device may comprising: a peripheral device configured to obtain at least one or more of a vehicle speed limit of a forward driving road, whether there is a gradient and gradient data as forward driving information; a memory configured to store at least one instruction; and a processor configured to execute the at least one instruction stored in the memory, wherein the processor is further configured to: calculate a total amount value of expected battery output energy based on the forward driving information that is input from the peripheral device, and determine a fuel cell power generation output value in a current driving road in order to charge or discharge a battery based on the total amount value of the expected battery output energy.

According to an example of the device of the present disclosure, the device of claim 11, wherein the total amount value of the expected battery output energy is determined by multiplying an expected battery discharge output value and an expected future driving time, and
wherein a required battery output value is determined by dividing the total amount value of the expected battery output energy by an expected driving time of the current segment.

According to an example of the device of the present disclosure, the device of claim 12, wherein based on the forward driving road being a long uphill, the processor is further configured to calculate an expected battery output value based on the input data, wherein the expected battery output value is an expected battery discharge output value, and wherein the expected battery discharge output value is calculated by subtracting an expected fuel cell power generation value from an expected gradient driving output value.

According to an example of the device of the present disclosure, the device of claim 12, wherein based on the forward driving road being a long downhill, the processor is further configured to calculate an expected battery output value based on the input data, wherein the expected battery output value is an expected battery charge output value, and wherein, the expected battery charge output value is an expected gradient driving output value during regenerative braking.

According to an example of the device of the present disclosure, the device of claim 12, wherein the total amount value of the expected battery output energy is determined by multiplying the expected battery charge or discharge output value and the expected future driving time.

According to an example of the device of the present disclosure, the device of claim 12, wherein the processor is further configured to determine a fuel cell power generation output value by correcting the required battery charge or discharge output value by a required vehicle output value for driving, and wherein the fuel cell power generation output value is determined by adding the required vehicle output value to the required battery charge or discharge output value.

According to an example of the device of the present disclosure, the device of claim 12 to claim 16, wherein the vehicle is a fuel cell vehicle.

According to an example of the device of the present disclosure, the device of claim 12, wherein based on the vehicle being a passenger hybrid vehicle, the required battery output value is converted into a battery charge or discharge output value by selecting one grade among a plurality of passenger vehicle power map grades.

According to an example of the device of the present disclosure, the device of claim 12, wherein the expected battery charge or discharge output value is compared with an expected fuel cell power generation output value, and wherein based on the expected battery charge or discharge output value being smaller than the expected gradient driving output value, smart power control for fuel cell power generation control is terminated.

According to an example of the device of the present disclosure, the device of claim 11, wherein whether or not to control fuel cell power generation is determined by comparing the total amount value of the expected battery output energy and a preset reference value.

According to the present disclosure, it is possible to provide a method and device for controlling a fuel cell power generation of a vehicle by calculating a battery SOC necessary for a future driving segment from forward driving information obtained from a peripheral device of the vehicle, charging or discharging a battery SOC beforehand through control of an amount of FC power generation in a current driving segment and thus controlling a battery SOC value.

The effects obtainable from the present disclosure are not limited to the above-mentioned effects, and other effects not mentioned herein will be clearly understood by those skilled in the art through the following descriptions.

While the methods of the present disclosure described above are represented as a series of operations for clarity of description, it is not intended to limit the order in which the steps are performed. The steps described above may be performed simultaneously or in different order, as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method for controlling fuel cell power generation, the method comprising:
determining, for a vehicle driving on a current driving segment of a road, upcoming driving segment information comprising, for an upcoming driving segment of the road:
a vehicle speed limit of the upcoming driving segment of the road, and
at least one of whether there is a gradient to the upcoming driving segment of the road, or gradient data of the upcoming driving segment of the road;
determining, based on the upcoming driving segment information, a total amount of expected battery output energy expected to be output by a battery of the vehicle while driving on the upcoming driving segment; and
while the vehicle is driving on the current driving segment, charging or discharging the battery based on a fuel cell power generation output value associated with the upcoming driving segment and on the total amount of the expected battery output energy.

2. The method of claim 1, wherein the total amount of the expected battery output energy is determined by multiplying an expected battery output value and an expected future driving time,
wherein the expected battery output value corresponds to an expected battery discharge output, and
wherein a required battery output value is determined by dividing the total amount of the expected battery output energy by an expected driving time of the current driving segment.

3. The method of claim 2, wherein, based on the upcoming driving segment information indicating the upcoming driving segment is uphill, the expected battery output value is determined as an expected battery discharge output value, and
wherein the expected battery discharge output value is obtained by subtracting an expected fuel cell power generation value from an expected gradient driving output value.

4. The method of claim 2, wherein, based on the upcoming driving segment information indicating the upcoming driving segment is downhill, the expected battery output value is determined as an expected battery charge output value, and
wherein, the expected battery charge output value is based on an expected gradient driving output value during regenerative braking.

5. The method of claim 2, wherein the total amount of the expected battery output energy is determined by multiplying the expected battery charge or discharge output value and an expected future driving time, and
wherein the expected battery output value corresponds to an expected battery charge output or an expected battery discharge output.

6. The method of claim 2, further comprising determining the fuel cell power generation output value by adjusting the required battery output value with a required vehicle output value for driving on the upcoming driving segment, and
wherein the fuel cell power generation output value is determined by adding the required vehicle output value to the required battery output value.

7. The method of claim 1, wherein the vehicle is a fuel cell vehicle equipped with a fuel cell power generator.

8. The method of claim 2, further comprising, based on the vehicle being a passenger hybrid vehicle, converting the required battery output value into a battery output value by selecting a grade among a plurality of passenger vehicle power map grades, wherein the battery output value corresponds to a battery charge output or a battery discharge output.

9. The method of claim 2, further comprising, based on the expected battery output value being smaller than an expected gradient driving output value associated with the upcoming driving segment information, terminating smart power control for fuel cell power generation.

10. The method of claim 1, further comprising determining whether or not to control the fuel cell power generation based on a comparison between the total amount of the expected battery output energy and a preset reference value.

11. A device, of a vehicle, for controlling fuel cell power generation for the vehicle by controlling a battery output, the device comprising:
a peripheral device configured to determine upcoming driving segment information comprising:
a vehicle speed limit of an upcoming driving segment of a road on which the vehicle is driving, and
at least one of whether there is a gradient of the upcoming driving segment or gradient data of the upcoming driving segment;
a processor; and
a memory configured to store at least one instruction that, when executed by the processor, configures the device to:
determine, based on the upcoming driving segment information, a total amount of expected battery output energy expected to be output by a battery of the vehicle while driving on the upcoming driving segment, and
while the vehicle is driving on a current driving segment of the road, charge or discharge the battery based on a fuel cell power generation output value associated with the upcoming driving segment and based on the total amount of the expected battery output energy.

12. The device of claim 11, wherein the total amount of the expected battery output energy is determined by multiplying an expected battery output value and an expected future driving time,
wherein the expected battery output value corresponds to an expected battery discharge output, and
wherein a required battery output value is determined by dividing the total amount of the expected battery output energy by an expected driving time of the current driving segment.

13. The device of claim 12, wherein, based on the upcoming driving segment information indicating the upcoming driving segment is uphill, the at least one instruction, when executed by the processor, further configures the device to determine the expected battery output value as an expected battery discharge output value by subtracting an expected fuel cell power generation value from an expected gradient driving output value.

14. The device of claim 12, wherein based on the upcoming driving segment information indicating the upcoming driving segment is downhill, the at least one instruction, when executed by the processor, further configures the device to determine the expected battery output value as an expected battery charge output value that is based on an expected gradient driving output value during regenerative break.

15. The device of claim 11, wherein the total amount of the expected battery output energy is determined by multiplying an expected battery output value and an expected future driving time, and
wherein the expected battery output value corresponds to an expected battery charge output or an expected battery discharge output.

16. The device of claim 12, wherein the at least one instruction, when executed by the processor, further configures the device to determine the fuel cell power generation output value by adjusting the required battery output value with a required vehicle output value for driving on the upcoming driving segment, and
wherein the fuel cell power generation output value is determined by adding the required vehicle output value to the required battery output value.

17. The device of claim 11, wherein the vehicle is a fuel cell vehicle equipped with a fuel cell power generator.

18. The device of claim 12, wherein, based on the vehicle being a passenger hybrid vehicle, the at least one instruction, when executed by the processor, configures the device to convert the required battery output value into a battery output value by selecting a grade among a plurality of passenger vehicle power map grades, and wherein the battery output value corresponds to a battery charge output or a battery discharge output.

19. The device of claim 12, wherein the at least one instruction, when executed by the processor, further configures the device to, based on the expected battery output value being smaller than an expected gradient driving output value associated with the upcoming driving segment information, terminate smart power control for fuel cell power generation.

20. The device of claim 11, wherein the at least one instruction, when executed by the processor, further configures the device to determine whether or not to control fuel cell power generation based on a comparison between the total amount of the expected battery output energy and a preset reference value.
